(19) United States
(12) Patent Application Publication
(10) Pub. No.: US 2026/0106192 A1
(43) Pub. Date: Apr. 16, 2026

(54) FUEL CELL SYSTEM

(71) Applicant: TOYOTA JIDOSHA KABUSHIKI KAISHA, Toyota-shi (JP)

(72) Inventor: Satoshi SHIOKAWA, Okazaki-shi (JP)

(73) Assignee: TOYOTA JIDOSHA KABUSHIKI KAISHA, Toyota-shi (JP)

(21) Appl. No.: 19/214,279

(22) Filed: May 21, 2025

(30) Foreign Application Priority Data
Oct. 15, 2024 (JP) 2024-180298

(51) Int. Cl. H01M 8/04746; H01M 8/04089

(52) U.S. Cl. CPC H01M 8/04761; H01M 8/04089; H01M 2250/20

(57) ABSTRACT

The fuel cell system includes a fuel cell, an exhaust pipe for discharging off-gas discharged from the fuel cell to the outside, a muffler provided in the exhaust pipe, and a pressure relief valve provided in the exhaust pipe upstream of the muffler or the muffler. The pressure relief valve may open when the pressure in the muffler is greater than or equal to a predetermined threshold value to reduce the pressure in the muffler.

### CROSS-REFERENCE TO RELATED APPLICATION

This application claims priority to Japanese Patent Application No. 2024-180298 filed on Oct. 15, 2024. The disclosure of the above-identified application, including the specification, drawings, and claims, is incorporated by reference herein in its entirety.

### BACKGROUND

### 1. Technical Field

The technology disclosed in the present specification relates to a fuel cell system.

### 2. Description of Related Art

Japanese Unexamined Patent Application Publication No. 2006-331884 (JP 2006-331884 A) discloses a fuel cell system. The fuel cell system according to JP 2006-331884 A includes a fuel cell, a gas passage, a valve device, and a control device. The fuel cell generates electric power by receiving a supply of reaction gas, and discharges reaction off-gas. The reaction gas or the reaction off-gas circulates through the gas passage. The valve device is disposed on the gas passage. The control device controls an opening degree of the valve device. The control device acquires pressure downstream of the valve device when the fuel cell system is started up, and controls the duty ratio of the valve device to a predetermined duty ratio when the pressure downstream is no greater than a predetermined pressurization completion pressure.

### SUMMARY

In a fuel cell system, a muffler may be provided in an exhaust pipe in order to suppress noise that is generated due to off-gas that is discharged from a fuel cell. In this configuration, when air is supplied to the fuel cell when the exhaust pipe is temporarily in a closed state or in a semi-closed state due to freezing or the like, there is concern that the muffler will be damaged due to increase in pressure in the muffler. Accordingly, the present specification provides technology that is capable of suppressing the muffler from being damaged.

According to a first aspect of the present technology, a fuel cell system includes
a fuel cell;
an exhaust pipe for externally discharging off-gas that is discharged from the fuel cell,
a muffler that is provided to the exhaust pipe, and
a pressure relief valve that is provided to the exhaust pipe, at the muffler or on an upstream side from the muffler.

The pressure relief valve may open when pressure in the muffler is no lower than a predetermined threshold value, so as to reduce the pressure in the muffler.

According to this configuration, the pressure relief valve opens when the pressure in the muffler is no lower than the threshold value, and accordingly the pressure in the muffler can be suppressed from rising excessively. Thus, the muffler can be suppressed from being damaged.

According to a second aspect, in the first aspect, the pressure relief valve may be provided to the muffler.

According to a third aspect, in the first or second aspect, the fuel cell system may further include a gas supply pipe for supplying an oxidizing gas to the fuel cell, and
a compressor that is provided to the gas supply pipe and that pressurizes the oxidizing gas to be supplied to the fuel cell.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a fuel cell system according to an embodiment;

FIG. 2A is a view schematically showing a closed state of a pressure relief valve according to an embodiment of the present example; and

FIG. 2B is a diagram schematically illustrating a diagram of a pressure relief valve according to an embodiment.

### DETAILED DESCRIPTION OF EMBODIMENTS

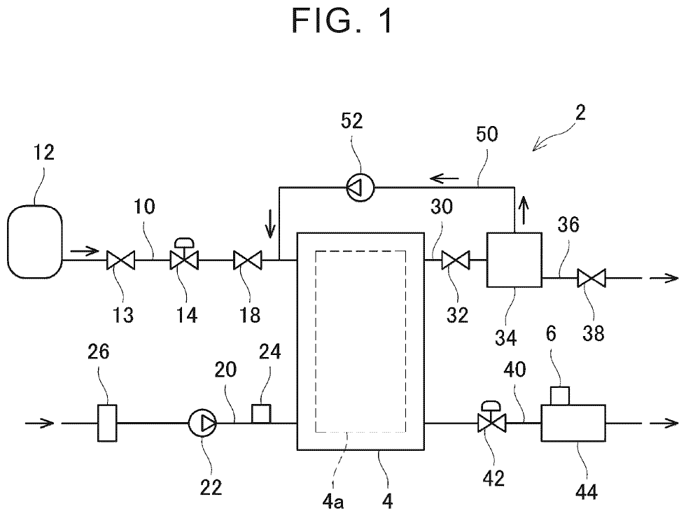

A fuel cell system 2 according to an embodiment will be described with reference to the drawings. As illustrated in FIG. 1, the fuel cell system 2 of the embodiment includes a fuel cell 4, a first gas supply pipe 10, a second gas supply pipe 20, a first exhaust pipe 30, and a second exhaust pipe 40 connected to the fuel cell 4. Further, the fuel cell system 2 includes a drainpipe 36 and a circulation pipe 50.

The fuel cell system 2 is mounted on a fuel cell electric vehicle, for example, and supplies electric power to a fuel cell electric vehicle driving motor. The fuel cell system 2 may be used in other than fuel cell electric vehicle. For example, the fuel cell system 2 may be used in a stationary power supply.

The fuel cell 4 is a device that generates electricity by a chemical reaction between hydrogen contained in the fuel gas and oxygen contained in the oxidizing gas. The fuel cell 4 includes a stacked 4a composed of a plurality of unit cells. The fuel cell 4 comprises one or more stacking 4a. Since the configuration of the fuel cell 4 is already known, a detailed description thereof will be omitted.

The upstream end of the first gas supply pipe 10 is connected to a tank 12 of a fuel gas (for example, a gas containing hydrogen), and the downstream end thereof is connected to the fuel cell 4. The first gas supply pipe 10 supplies the fuel gas stored in the tank 12 to the fuel cell 4. The tank 12 stores fuel gas to be supplied to the fuel cell 4 at a high pressure.

The first gas supply pipe 10 is provided with a tank valve 13, a pressure regulating valve 14, and an inlet valve 18 in this order from the upstream side. When the tank valve 13, the pressure regulating valve 14, and the inlet valve 18 are opened, the fuel gas is supplied from the tank 12 to the fuel cell 4.

The pressure regulating valve 14 regulates (reduces) the pressure of the fuel gas in the first gas supply pipe 10 so that the pressure of the fuel gas on the downstream side of the pressure regulating valve 14 is lower than the pressure of the fuel gas on the upstream side of the pressure regulating valve 14.

The upstream end of the second gas supply pipe 20 is open to the outside of the fuel cell system 2, and the downstream end thereof is connected to the fuel cell 4. The second gas supply pipe 20 supplies an oxidizing gas (for example, air containing oxygen) supplied from the outside to the fuel cell 4. The second gas supply pipe 20 is provided with a filter 26, a compressor 22, and a pressure sensor 24 in this order from the upstream side.

The filter 26 removes foreign matter (e.g., dust) contained in the oxidizing gas supplied to the fuel cell 4 through the second gas supply pipe 20. The compressor 22 pressurizes and feeds the oxidizing gas to the downstream side of the second gas supply pipe 20. That is, the compressor 22 pressurizes the oxidizing gas supplied to the fuel cell 4. When the compressor 22 operates, the pressurized oxidizing gas is supplied to the fuel cell 4 through the second gas supply pipe 20. The pressure sensor 24 detects the pressure of the oxidizing gas in the second gas supply pipe 20. That is, the pressure sensor 24 detects the pressure of the oxidizing gas supplied to the fuel cell 4 through the second gas supply pipe 20.

The upstream end of the first exhaust pipe 30 is connected to the fuel cell 4, and the downstream end thereof is connected to the gas-liquid separator 34. The first exhaust pipe 30 discharges the off-gas of the fuel gas discharged from the fuel cell 4 to the gas-liquid separator 34. The off-gas of the fuel gas contains gaseous hydrogen and liquid water. An outlet valve 32 is provided in the first exhaust pipe 30, and when the outlet valve 32 is opened, the off-gas of the fuel gas is discharged from the fuel cell 4 to the gas-liquid separator 34. The gas-liquid separator 34 separates the gas (hydrogen) and the liquid (water) contained in the off-gas of the fuel gas.

The upstream end of the drainpipe 36 is connected to the gas-liquid separator 34, and the downstream end thereof is open to the outside of the fuel cell system 2. The drainpipe 36 discharges the liquid (water) separated in the gas-liquid separator 34 to the outside of the fuel cell system 2. An on-off valve 38 is provided in the drainpipe 36, and when the on-off valve 38 is in the open state, the liquid (water) is discharged from the gas-liquid separator 34 to the outside of the fuel cell system 2. The downstream end of the drainpipe 36 may be connected to the second exhaust pipe 40.

The upstream end of the circulation pipe 50 is connected to the gas-liquid separator 34, and the downstream end thereof is connected to the first gas supply pipe 10. The downstream end of the circulation pipe 50 is connected to the first gas supply pipe 10 downstream of the inlet valve 18. The circulation pipe 50 supplies the gas (hydrogen) separated in the gas-liquid separator 34 to the first gas supply pipe 10. A compressor 52 is provided in the circulation pipe 50, and when the compressor 52 is operated, the gas (hydrogen) separated in the gas-liquid separator 34 is supplied to the first gas supply pipe 10.

The upstream end of the second exhaust pipe 40 is connected to the fuel cell 4, and the downstream end thereof is open to the outside of the fuel cell system 2. The second exhaust pipe 40 discharges the off-gas of the oxidizing gas discharged from the fuel cell 4 to the outside of the fuel cell system 2. The second exhaust pipe 40 is provided with a pressure regulating valve 42 and a muffler 44 in this order from the upstream side.

The pressure regulating valve 42 regulates (reduces) the pressure of the off-gas in the second exhaust pipe 40 so that the pressure of the off-gas on the downstream side of the pressure regulating valve 42 is lower than the pressure of the off-gas on the upstream side of the pressure regulating valve 42. The pressure regulating valve 42 regulates the pressure of the off-gas in the second exhaust pipe 40 so that the pressure of the oxidizing gas in the fuel cell 4 becomes an appropriate pressure.

The muffler 44 is a device that suppresses the sound generated due to the off-gas flowing through the second exhaust pipe 40. The configuration of the muffler 44 is not particularly limited. The muffler 44 includes, for example, a casing and a sound absorbing material filled in the casing. In another example, the muffler 44 may include a meandering flow path through which the off-gas passes, thereby suppressing sound generated due to the off-gas. The off-gas having passed through the muffler 44 is discharged to the outside of the fuel cell system 2.

The muffler 44 is provided with a pressure relief valve 6. The pressure relief valve 6 is a device that opens when the pressure of the off-gas in the muffler 44 becomes equal to or higher than a predetermined threshold value, thereby reducing the pressure of the off-gas in the muffler 44.

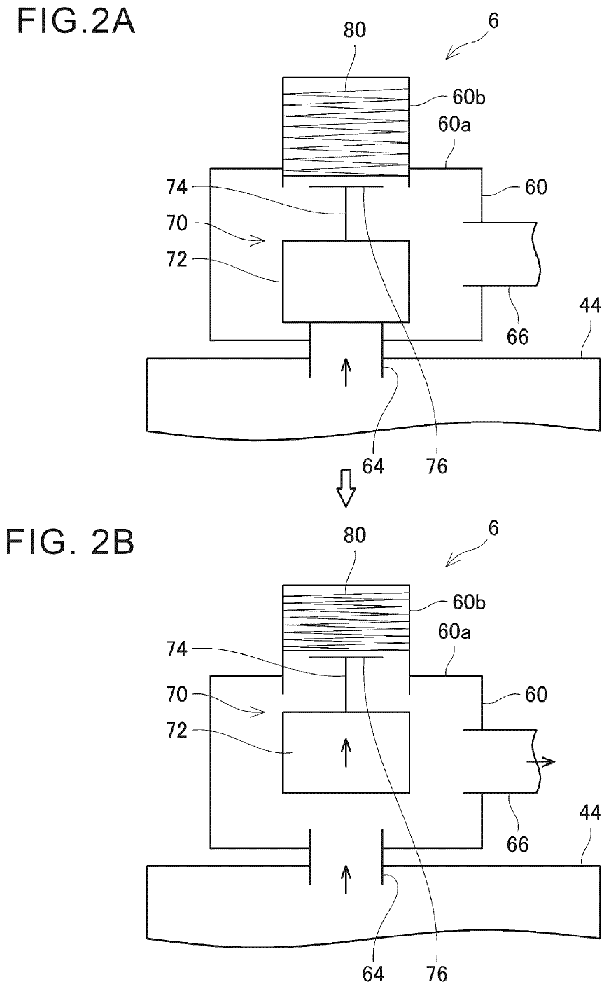

The specific configuration of the pressure relief valve 6 is not particularly limited. For example, as shown in FIGS. 2A and 2B, the pressure relief valve 6 includes a casing 60, an upstream pipe 64, a downstream pipe 66, a valve member 70, and a spring member 80. The casing 60 comprises a first partial 60a for receiving the valve member 70 and a second partial 60b for receiving the spring member 80.

An upstream end of the upstream pipe 64 is connected to the muffler 44, and a downstream end thereof is connected to the casing 60 of the pressure relief valve 6. The upstream pipe 64 discharges the off-gas in the muffler 44 into the casing 60 of the pressure relief valve 6 when the pressure relief valve 6 is in the open state.

The upstream end of the downstream pipe 66 is connected to the casing 60 of the pressure relief valve 6, and the downstream end thereof is open to the outside of the fuel cell system 2. The downstream pipe 66 discharges the off-gas in the casing 60 of the pressure relief valve 6 to the outside.

The valve member 70 is accommodated in the first partial 60a of the casing 60. The valve member 70 receives the pressure of the off-gas in the muffler 44 via the upstream pipe 64. The valve member 70 opens and closes the outlet of the upstream pipe 64 in response to the pressure of the off-gas in the muffler 44. The valve member 70 includes a main body portion 72, a pressing portion 76, and a shaft portion 74.

The body portion 72 receives the pressure of the off-gas in the muffler 44. The pressing portion 76 presses the spring member 80 in response to the body portion 72 receiving the pressure of the off-gas. The shaft portion 74 connects the main body portion 72 and the pressing portion 76.

The spring member 80 is accommodated in the second partial 60b of the casing 60. The spring member 80 is configured to be expandable and contractible, and presses the pressing portion 76 of the valve member 70. The spring member 80 contracts when the pressure of the off-gas in the muffler 44 received by the valve member 70 becomes equal to or higher than a predetermined threshold value. As shown in FIG. 2B, the spring member 80 contracts, and the pressure relief valve 6 is opened. When the pressure relief valve 6 is opened, the off-gas in the muffler 44 is discharged to the outside of the fuel cell system 2 through the upstream pipe 64, the casing 60, and the downstream pipe 66 of the pressure relief valve 6. As a result, the pressure in the muffler 44 is reduced.

### Effects

The fuel cell system 2 of the embodiment has been described above. As is apparent from the above description, the fuel cell system 2 includes a second exhaust pipe 40 for discharging the off-gas discharged from the fuel cell 4 to the outside, a muffler 44 provided in the second exhaust pipe 40, and a pressure relief valve 6 provided in the muffler 44. The pressure relief valve 6 opens when the pressure in the muffler 44 becomes equal to or higher than a predetermined threshold value to reduce the pressure in the muffler 44.

According to this configuration, when the pressure in the muffler 44 becomes equal to or higher than the threshold value, the pressure relief valve 6 is opened, so that it is possible to suppress the pressure in the muffler 44 from being excessively increased. Thus, the muffler 44 can be suppressed from being damaged.

Further, since the pressure relief valve 6 is provided in the muffler 44, the pressure in the muffler 44 can be directly reduced, and the muffler 44 can be prevented from being damaged.

Further, the fuel cell system 2 includes a compressor 22 provided in the second gas supply pipe 20. The compressor 22 pressurizes the oxidizing gas supplied to the fuel cell 4. According to this configuration, since the compressor 22 pressurizes the oxidizing gas supplied to the fuel cell 4, the pressure of the off-gas discharged from the fuel cell 4 also increases, so that the pressure in the muffler 44 increases. Therefore, the configuration of the pressure relief valve 6 for suppressing the pressure in the muffler 44 from excessively increasing is particularly effective.

In addition, according to the fuel cell system 2 of the embodiment, since the pressure relief valve 6 operates alone, a sensor for pressure detection, a control system, and the like are not required, so that the cost can be reduced and the size can be reduced.

### Modification

In the above embodiment, the pressure relief valve 6 is provided in the muffler 44, but is not limited to this configuration. In a modification, the pressure relief valve 6 may be provided in the second exhaust pipe 40. In this case, the pressure relief valve 6 is provided in the second exhaust pipe 40 upstream of the muffler 44 and downstream of the pressure regulating valve 42. Also in this configuration, the pressure relief valve 6 opens when the pressure in the muffler 44 becomes equal to or higher than a predetermined threshold value to reduce the pressure in the muffler 44.

Although specific examples of the disclosure have been described in detail above, the examples are merely examples and do not limit the scope of claims. The technique described in the claims includes various modifications and variations of the specific examples exemplified above. The technical elements described in this specification or in the drawings exhibit technical utility alone or in various combinations, and are not limited to the combinations described in the claims at the time of filing. Further, the technology illustrated in the present specification or the drawings can achieve a plurality of objects at the same time, and has technical usefulness by achieving one of the objects.

What is claimed is:

1. A fuel cell system, comprising:
a fuel cell;
an exhaust pipe for externally discharging off-gas that is discharged from the fuel cell;
a muffler that is provided to the exhaust pipe; and
a pressure relief valve that is provided to the exhaust pipe, at the muffler or on an upstream side from the muffler, wherein
the pressure relief valve opens when pressure in the muffler is no lower than a predetermined threshold value, so as to reduce the pressure in the muffler.

2. The fuel cell system according to claim 1, wherein the pressure relief valve is provided to the muffler.

3. The fuel cell system according to claim 1, further comprising:
a gas supply pipe for supplying an oxidizing gas to the fuel cell; and
a compressor that is provided to the gas supply pipe and that pressurizes the oxidizing gas to be supplied to the fuel cell.
